(19) United States
(12) Patent Application Publication
(10) Pub. No.: US 2004/0142092 A1
(43) Pub. Date: Jul. 22, 2004

(54) Marshmallow

(76) Inventor: Jason Long, Danbury, CT (US)

Correspondence Address: Jason Long, 13 Valerie La, Danbury, CT, 06811, US

(21) Appl. No.: 10/346,223

(22) Filed: Jan. 18, 2003

(51) Int. Cl. A23G 3/00

(52) U.S. Cl. 426/660

(57) ABSTRACT

An improved marshmallow, consisting of an existing or new marshmallow item or shape, which has been infused with, co-extruded with, molded with or injected with a flavored filling, at the time of manufacture or at a later date. In addition, marshmallow could be drop formed over or onto said flavored filling. Said flavored filling could be a simple chocolate or jelly, or a more complex combination of ingredients, that impart the taste of an easily recognizable popular brand name confection such as, Reese's™ peanut butter cups, Milky Ways™ or Snickers™ candies to name a few. Or said flavored filling could impart the taste of a popular liquor such as Ballies Irish cream™, Amaretto™, or Sambooka™. Said flavored filling could also be a combination of ingredients that create a new flavor or taste, be fortified with vitamins and or minerals to make the product more nutritious, or contain a pharmaceutical and thus be used as a delivery medium for a medicine, medication, antibiotic or vaccine, therefore making it much easer to administer to a child, or much more pleasant for an adult.

### PRIORITY CLAIM

This Application claims priority to, and incorporates by reference, U.S. Provisional Patent Application No. 60/348,841, which was filed on Jan. 17, 2002.

### FIELD OF INVENTION

This invention relates to a food product for human consumption. More particularly it relates to an aerated confection, such as marshmallow.

### BACKGROUND OF INVENTION

Confections are broken down into three major groups: hard candies, chewing confections, e.g., kisses, gums and jellies, and aerated or whipped items, e.g., nougats and marshmallows. Both chewy and aerated confections can be further classified into two sub-groups, grained and non-grained candies. Grained candies are made from supersaturated sucrose solution while non-grained candies are made from unsaturated sucrose solutions. The basic composition for marshmallows of all kinds includes water, a disaccharide sugar such as sucrose, a monosaccharide sugar such as dextrose or corn syrup, and a whipping agent such as gelatin. Suitable flavor and coloring materials may also be incorporated into the basic composition. Among the many formulas that are known for marshmallow production are those found in the following: “Candy Making as a Science and as an Art,” by Claude D. Barnett, Don Gussow Publications, Inc., New York, 1960, pp. 99-103; “An Encyclopedia of Candy and Ice Cream Making,” by Simon I. Leon, Chemical Publishing Company, New York, 1969, pp. 294-304, and, “A Textbook on Candy Making,” by Alfred E. Leighton, The Manufacturing Confectioner Publishing Company, Oak Park, Ill., 1952, pp. 55-58. See-also, for example, U.S. Pat. No. 3,607,309, issued Sep. 21, 1961 to E. S. Olney et al, and U.S. Pat. No. 2,847,311, issued Aug. 12, 1958 to Alexander J. Doumak. Soft marshmallow or “long grain” marshmallow has an elastic and chewy consistency and is the type usually associated with the term “marshmallow”. Sugar ratios are so regulated so that crystallinization of the sugars or “graining” does not take place within a reasonable period of time. To accomplish this reduction in the tendency to crystallize, corn syrup of various dextrose equivalents (“DE”) have been employed to inhibit the onset of crystallinization. Hard marshmallows or “short grain” marshmallows, on the other hand, have a rigid consistency and are composed of suitable sugars in ratios such that one or more of the disaccharide sugars will crystallize and provide a grained structure. Examples of such compositions are the candy-kisses popular in small, heart-shaped candies which are popular for Valentine's Day. While either type of marshmallow would be suitable for this invention, “long grain” or soft marshmallow will be the preferred embodiment of the further discussion.

Historically marshmallows have had a very limited market, being restricted to seasonal treats such as, the summer campfire favorite, S'more, and the traditional marshmallow topped sweet potatoes at Thanksgiving. Also popular is the marshmallow floating atop the occasional cup of hot chocolate in winter times, the various novelty item in an Easter basket and more recently, marshmallows have been used, in the making of rice crispy treats for the school bake sale. Although marshmallows are a fat free food, and as such are a good choice for snacking or desert, especially for those trying to maintain a low fat diet, they have had limited consumer appeal do to the fact that they are perceived as being bland and plain and generally unexciting and boring. Though the appearance of a bag of marshmallows will usually generate excitement in a group of individuals of any age, the excitement generally fades after the ingestion of just a few marshmallows. For this reason, marshmallows have never in the past achieved a strong position in the market place as a stand-alone product.

### SUMMARY OF THE INVENTION

It is an object of this invention to create the means to facilitate the cross marketing of popular brand names through this hereunto unobvious and unnoticed market niche.

Anyone that has taken a trip to the grocery store or supermarket in the past few years, or even watched the TV for that matter, has surely noticed the growing trend in “cross marketing”, especially in food items. That is to say that there was a time in the past, when a product was marketed and sold, solely on its own unique properties and taste. Different manufactures of similar products would settle on a distinct taste and then focus their efforts on promoting their distinct taste through a brand name. Brand name recognition has long been the battle cry of Madison Av, and to this ends it must be conceded that they have been most successful. In fact the scales may have tipped to the point that the “brand name” is more valuable than the distinct taste. As evidence of this one will notice that such names as Reese's™ is no longer confined to the candy isle, but can now be found on breakfast cereals, ice creams and cookies. By means of this invention, the flavored filling of the marshmallow, could be formulated to replicate the distinct taste of a popular brand name such as Reese's™ for example, and further increase the value of said brand name. A brief inspection of the section of the candy isle of any supermarket, that is dedicated to marshmallows, will bear witness to the fact that this segment of the food industry, has been totally unrealized, unnoticed and overlooked, as a means for the further marketing of brand names, and thus bears witness to the fact that the subject of this invention is obviously quite novel and unobvious.

It is a further object of this invention to create a simplified and significant safer way, to make S'mores, the popular campfire treat, while also creating the potential for new and until now unknown tastes and variations, when making a S'mores.

Anyone who has ever made a s'mores either around the campfire or the backyard barbecue, is well aware of the potential hazards inherent in its production. The skill required to balance a piece of chocolate bar on a graham cracker and at the same time pinch the marshmallow between the chocolate bar/gram cracker combo, with sufficient pressure as to retain the marshmallow and chocolate as you withdraw the roasting skewer, but not so much pressure as to force the hot marshmallow out onto your fingers is normally difficult for a grown up to master, let alone a child, and can often lead to quite a nasty burn on the fingers. Although these burns are usually not life threatning, they can nun the less be quite painful, and will quickly put a damper on the family fun. With the improved marshmallow, the chocolate is already in the marshmallow, thus eliminating the need to master this risky balancing act, and also allows one to enjoy a very tasty treat when eaten directly from the stick. Furthermore if the improved marshmallow chosen, is one which contains a brand name filling for example Milky Way™ or Bailey's Irish cream™, a person would be in for a whole new experience and taste treat. It is a further object of this invention, to create an exciting and fun food product, that helps individuals trying to maintain a low fat diet, buy providing a low fat snack that has the popular, or brand name flavors that they crave, but with significantly lower fat content. Although traditional marshmallows are a fat free food, and as such are a good alternatice for individuals trying to limit there fat intake to snack on, traditional marshmallows can soon become boring to consume, and dieters will loose interest in them and start to crave the high fat, high calorie, brand name snack food or candy, that they feel will satiate there apatite. Anyone who has ever found themselves in this predicament is well aware of the daily internal struggle and frustration that this can introduce into ones life. But with the introduction of a remarkably small amount of a brand name, or other flavored filling, into a traditional style marshmallow, and when said marshmallow is subsequently consume, the same hunger satisfying effect can be achieved. with substantially lower fat intake, than one would incur, if they were to consume the original high fat snack food or candy, of there desire. A further object of this invention is to provide a pleasant, palatable delivery mechanism, for the dispensing of over the counter, and or prescription drugs and medications. Any one who has had to give a medication to a child, young adult, or household pet, has experienced the problem of getting them to take the second and subsequent doses. You may not have much trouble getting the first dose into them, but you know the old saying, “You can fool them once, but you can't fool them twice”) Therefore it is an object of this invention to create a pleasant fun way for children, young adults, adults and/or animal, to take there medicine or medication, by inserting or injecting said medicine or medication into said marshmallow product, at time of manufacture, or as a secondary step after the original time of maufacture, or by inserting or injecting said machine or medication into said mashmallow just prior to the administering or consumption of said mashmallow containing medicine or medicine or medication. This invention would also greatly advance the efforts of medical, humanitarian, and said organizations, in the administering of vaccinations and medications, in the developed, developing and third world nations. Also, any healthcare worker, who has spent any time assisting the elderly, or those undergoing chemo or other such medical treatments, well knows the problems incurred, due to unpalatable thou life saving medicines and medications, that those in there care must take and keep down. It is an object of this invention to allow for the creation of a whole new line of products, that finally address these serious issues, that sooner or later touches all of our lives.

### DETAILED DESCRIPTION OR THE INVENTION

The new and novel product of this invention is an improved marshmallow, created by means of utilizing an existing or new marshmallow item or shape, in combination with a flavored or fortified filling. Any industry accepted marshmallow base product, such as those disclosed by E. S. Olney et al, in U.S. Pat. No. 3,607,309 issued Sept. 21, 1961, and Alexander J. Doumak, in U.S. Pat. No. 2,847,311, issued Aug. 12, 1958, and any other marshmallow base product as is known and/or is obvious to those trained in the art of confection manufacture, should be wholly suitable as the marshmallow component of this invention. The said filling component of this invention, could be a simple chocolate or jelly, or a more complex combination of ingredients, that impart the taste of an easily recognizable popular brand name confection such as, Reese's ™ peanut butter cups, Milky Way™, or Snickers™ candies, to name a few, or said filling could impart the taste of a liquor such as Bailey's Irish cream ™, Amaretto™ or Sambuca™. Said filling could also contain a medicine and/or medication vaccination and/or other health related product. The desired results of this invention could be attained by, but not limited to, the infustion of said flavor or flavors, into the marshmallow base syrup before or after aeration. By mixing or swirling or said filling or flavor component, directly into the mashmallow base syrup before or after aeration, or said filling could be co-extruded with, molded with or injected into any marshmallow item or shape after forming, as secondary process. In addition mashmallow could be drop formed over or onto said flavored filling. An additional embodiment of this invention, is one in which the filling component of this invention, would be supplied uncombined with the marshmallow component of this invention, in say an ampoule, injection device, or an other form suitable for the insertion or injection into the marshmallow component of this invention, and would be injected or inserted into the marshmallow component, at some point prior to ingestion of the product of this invention. This last method may be the preffered embodiment when working with controlled and/or perishable substances. It is also anticipated in this invention, that the said filling, be it only a tasty filling, or one which is fortified with vitamins and/or minerals, and/or some form of pharmaceutical, could be supplied by its self, in an ampoule, injection device, or an other form suitable for the insertion or injection into a marshmallow, and the procurement of the marshmallow would be left up to the end user. In addition, said desired taste or functional results of this invention, could be attained by, first infusing the marshmallow component with a flavor, and then addinn the filling component of this invention, by a combination of any and all of the said methods listed, along with other methods obvious or known to those trained in the art of candy and confection manufacture. In some instances, depending on the grain structure, aeration, and other variables that effect the final elastic and other physical characteristics of the marshmallow component of this invention, it may be beneficial to heat the filling component to a temperature, sufficient enough to melt a cavity inside the marshmallow component, to allow said filling component to remain within said marshmallow component, withour the marshmallow component, rejecting or ejecting, the filling component, dur to elastic stress. This would be most applicable to a product that is manufactured by means of the filling component being injected into the marshmallow component as a secondary step.

What is claimed:

1. A marshmallow food product that is infused with a favorer, or combination of flavors.

2. A marshmallow food product that is infused with a favorer, or combination of flavors, to replicate or impart the taste of a brand name food, confection, candy product or liquor, such as Reese's ™ peanut butter cup, Milky Way™, or Snickers™, Bailey's Irish cream™. Amaretto™ or Sambuca™, and follows for the cross marketing of

3. A composite marshmallow food product that is the combination of a first marshmallow food product and a second flavored food product.

4. A composite marshmallow food product that is the combination of a first marshmallow food product and a second flavored food product, to replictae or impart the tast of a brand name food confection, candy product or liquor, such as Reese's ™ peanut butter cup, Milky Way™, or Snickers™, Bailey's Irish cream ™, Amaretto™ or Sambuca™, and allows for the cross marketing of established brand names.

5. The composite marshmallow food product of claim 3 and/or 4, wherein the second flavored food product, is compounded from a brand name food, candy, confection or liquor, such as Reese's ™ peanut butter cup, Milky Way™, or Snickers™, Bailey's Irish cream™, Amaretto™ or Sambuca™.

6. The composite marshmallow food product of claimes 3 and/or 4, wherein the second flavored food product, is compounded to replicate the taste and flavor of a brand name food, candy, confectio or liquor, such as Reese's ™ peanut butter cup, Milky Way™, or Snickers™, Bailey's Irish cream™, Amaretto™ or Sambuca™.

7. The composite marshmallow food product of claim 3 and/or 4, wherein the second flavored food product, contains a substances such a vitamins and or minerals.

8. The compostie marshmallow food product of claim 3 and/or 4, wherein the second flavored food product, contains, a medicine, medication, antibiotic or vaccine, or other pharmaceutical, or health product.

9. A mehtod of manufacturing the composite marshmallow food product of claim 3 and/or 4, wherein the second flavored food product, is mixed or swirled directly into the base syrup of the first marshmallow food product, before or after aeration

10. A method of manufacturing the composite marshmallow food product of claim 3 and/or 4, wherein the second flavored food product, is co-extruded with the first marshmallow food product.

11. A method of manufacturing the composite marshmallow food product of claim 3 and/or 4 wherein the second flavored food product, is molded with or into the first marshmallow food product.

12. A method of manufacturing the composite marshmallow food product or claim 3 and/or 4, wherein the second flavored food product is injected into the first marshmallow food product as a secondary operation.

13. A method of manufacturing the composite marshmallow food product of claim 3 and/or 4, wherein the second flavored food product, is heated to a temperature, prior to injecting into the marshmallow food product as a secondary operation.

14. A mehtod of manufacturing the composite marshmallow food product of claim 3 and/or 4, wherein the second flavored food product is supplied in an ampoule, injection device, or an other form suitable for the insertion or injection of the second flavored food product, into the first marshmallow food product and would be injected or inserted into the marshmallow food product, at some point prior to ingestion of the product.

15. A method of manufacturing the composite marshmallow food product of claim 3 and/or 4, wherein the second flavored food product is suppllied in an ampoule, injection device, and/or an other device or form, suitable for the insertion or injection of the second flavored food product into a marshmallow, wherein the procurement of the marshmallow is left up to the end user.

16. A composite marshmallow food product that is the combination of a first marshmallow food product and a second fortified food product, wherein the second fortified food product containes a vitamin and/or mineral, and/or medicine, medication, antibiotic or vaccine, or other pharmaceutical, or health product.

17. A method of manufacturing the composite marshmallow food product of claim 15, wherein the second fortified food product, is mixed or swirled directly into the base syrup of the first marshmallow food product, before or after aeration

18. A method of manufacturing the composite marshmallow food product of claim 15, wherein the second fortified food product, is co-extruded with the first marshmallow food product.

19. A method of manufacturing the composite marshmallow food product of claim 15, wherein the second fortified food product, is molded with or into the first marshmallow food product.

20. A method of manufacturing the composite marshmallow food product or claim 15, wherein the second fortified food product is injected into the first marshmallow food product as a secondary operation.

21. A method of manufacturing the composite marshmallow food product of claim 15, wherein the second fortified food product, is heated to a temperature, prior to injecting into the marshmallow food product as a secondary operation.

22. A method of manufacturing the composite marshmallow food product of claim 15, wherein the second fortified food product is supplied in an ampoule, injection device, or am other form suitable for the insertion or injection of the second fortified food product, into the first marshmallow food product and would be injected or inserted into the marshmallow food product, at some point prior to ingestion of the product.

23. A method of manufacturing the composite marshmallw food product of claim 15, wherein the second fortified food product is supplied in an ampoule, injection device, and/or an other device or form, suitable for the insertion or injection of the second fortified food product into a marshmallow, wherein the procurement of the marshmallow is left up to the end user.
